(19) United States
(12) Patent Application Publication
(10) Pub. No.: US 2011/0291400 A1
(43) Pub. Date: Dec. 1, 2011

(54) Privacy Cover System

(76) Inventor: Shawn M. Asbenson, Salem, OR (US)

(21) Appl. No.: 12/478,209

(22) Filed: Jun. 4, 2009

Related U.S. Application Data
(63) Continuation-in-part of application No. 12/163,474, filed on Jun. 27, 2008.

(51) Int. Cl. B42D 15/00

(52) U.S. Cl. 283/74

(57) ABSTRACT

A privacy cover system for efficiently increasing the privacy of an information card by reducing the visibility of the card at offset angles. The privacy cover system generally includes a privacy cover to attach to an information card over at least a portion of information upon the information card, wherein the privacy cover aligns with the information of the information card. The privacy cover is adapted to allow viewing of the information of the information card through the privacy cover over a first range of angles (i.e. viewing angles) and is adapted to prevent viewing of the information of the information card through the privacy cover over a second range of angles (i.e. restricting angles) by distorting the information.

### CROSS REFERENCE TO RELATED APPLICATIONS

I hereby claim benefit under Title 35, United States Code, Section 120 of U.S. patent application Ser. No. 12/163,474 filed Jun. 27, 2008. This application is a continuation in-part of the Ser. No. 12/163,474 application. The Ser. No. 12/163,474 application is currently pending. The Ser. No. 12/163,474 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to information cards and more specifically it relates to a privacy cover system for efficiently increasing the privacy of an information card by reducing the visibility of the card at offset angles.

2. Description of the Related Art

Any discussion of the related art throughout the specification should in no way be considered as an admission that such related art is widely known or forms part of common general knowledge in the field.

Information cards have been in use for years and are utilized by many people as a means to identify themselves or a particular item, and also as a means of payment such as in credit cards. Information cards generally include enough information to identify the individual or the particular account or purpose of the card. This can make various types of information cards popular among individuals in that they are often easy to carry around and utilize.

It can be very easy for a nearby individual to “peek” over the shoulder, photograph or get a glance at another individual's information card. In addition, the nearby individual may be able to peek long enough to take notice of, remember and photograph a particular identification number or characteristic upon the information card. This can result in the nearby individual using the other's information card or knowledge of their card without consent. Because of the inherent problems with the related art, there is a need for a new and improved privacy cover system for efficiently increasing the privacy of an information card by reducing the visibility of the card at offset angles.

### BRIEF SUMMARY OF THE INVENTION

A system for efficiently increasing the privacy of an information card by reducing the visibility of the card at offset angles. The invention generally relates to an information card which includes a privacy cover to attach to an information card over at least a portion of information upon the information card, wherein the privacy cover aligns with the information of the information card. The privacy cover is adapted to allow viewing of the information of the information card through the privacy cover over a first range of angles (i.e. viewing angles) and is adapted to prevent viewing of the information of the information card through the privacy cover over a second range of angles (i.e. restricting angles) by distorting the information.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention exploded from an information card, wherein the information card is comprised of a transaction card.

FIG. 2 is a front view of the present invention attached to an information card, illustrating the card at a straight on viewing angle.

FIG. 3 is an upper perspective view of the present invention attached to an information card, illustrating the card slightly rotating toward a restricting view and a portion of the information becoming covered as the card is being rotated.

FIG. 4 is an upper perspective view of the present invention attached to an information card, illustrating the card at a skew restricting angle.

FIG. 5 is a longitudinal cross-sectional view of the present invention attached to an information card.

FIG. 6 is an upper perspective view of the present invention attached to an information card, illustrating the card at a skew restricting angle and the present invention sized to cover only the information of the credit card illustrating the account number.

FIG. 7 is an upper perspective view of the present invention exploded from an information card, wherein the information card is comprised of a playing card.

FIG. 8 is a front view of the present invention attached to an information card, illustrating the information upon the card distorted.

FIG. 9 is a front view of the present invention attached to only a portion of the information card, illustrating the portion of the information upon the card distorted.

FIG. 10 is an illustrative diagram of possible viewing angles and restricting angles with respect to the cover attached to the information card.

### DETAILED DESCRIPTION OF THE INVENTION

### A. Overview

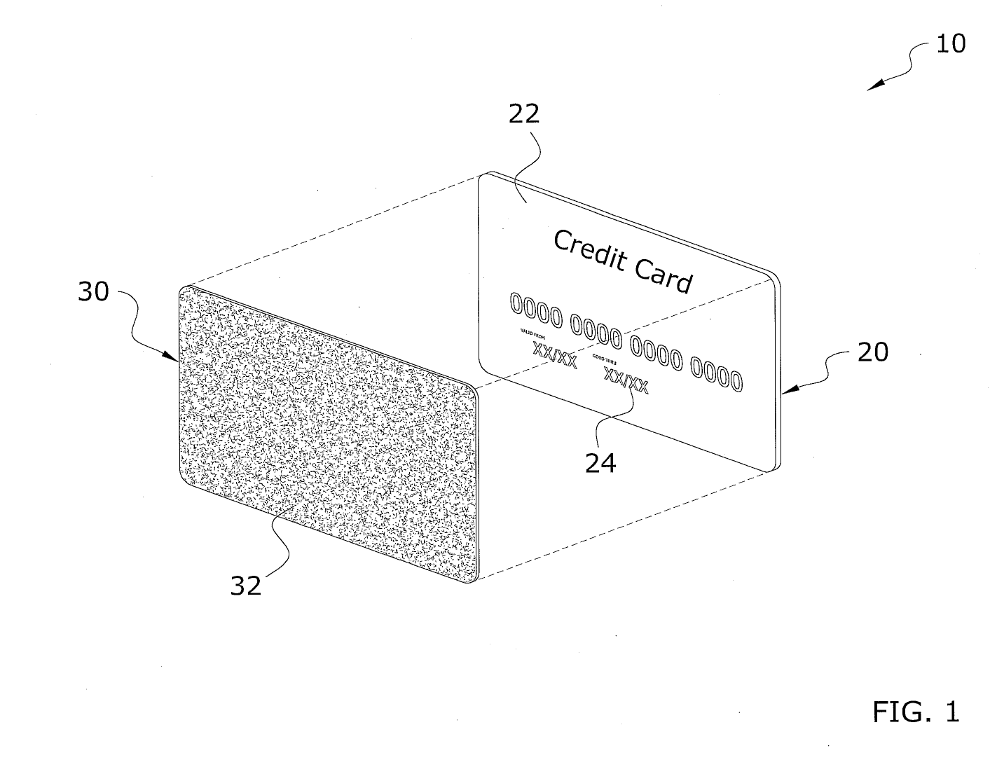

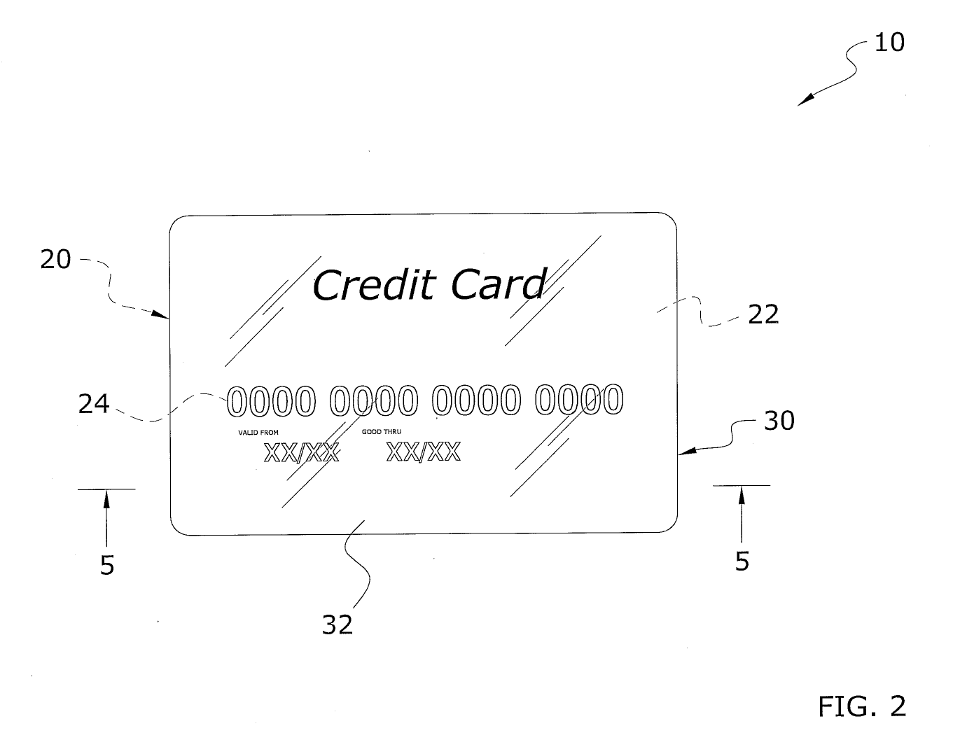

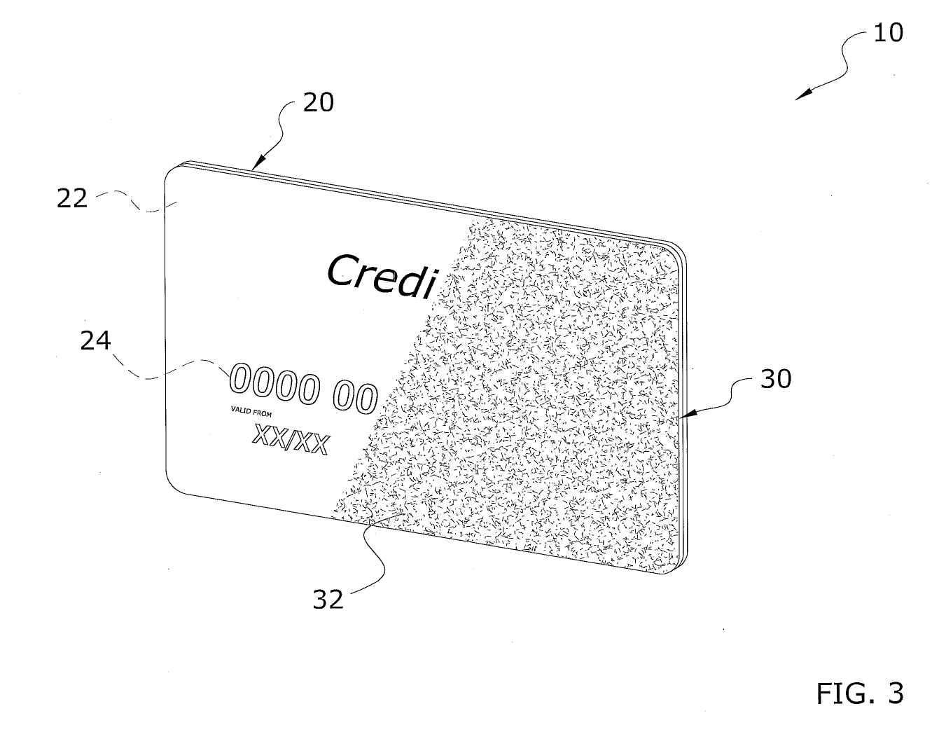

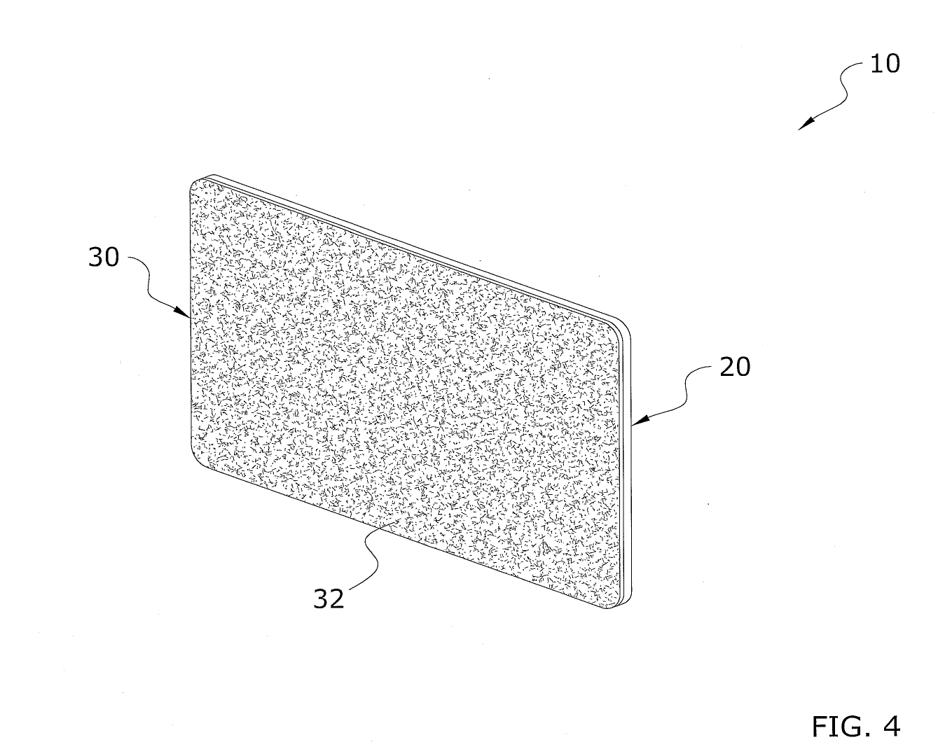

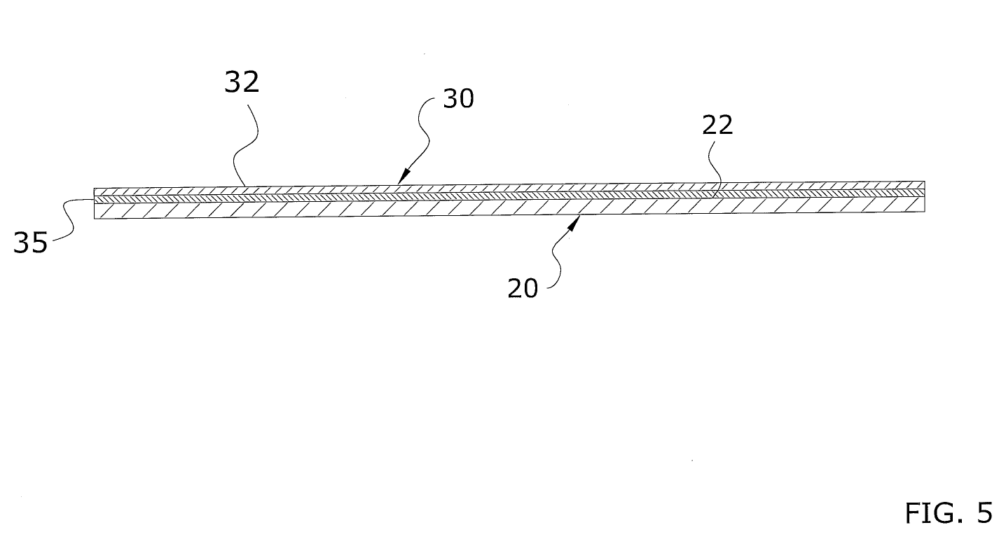

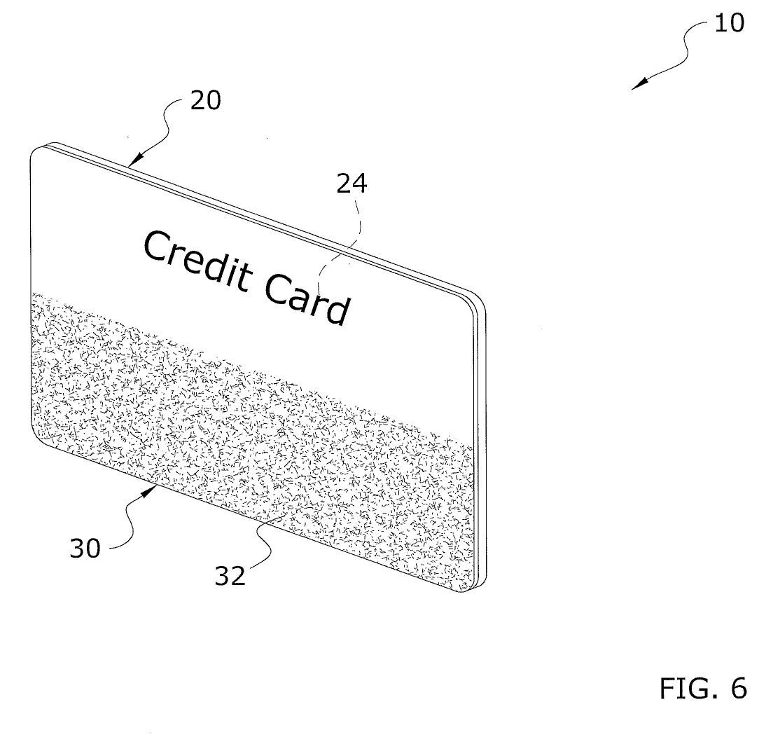

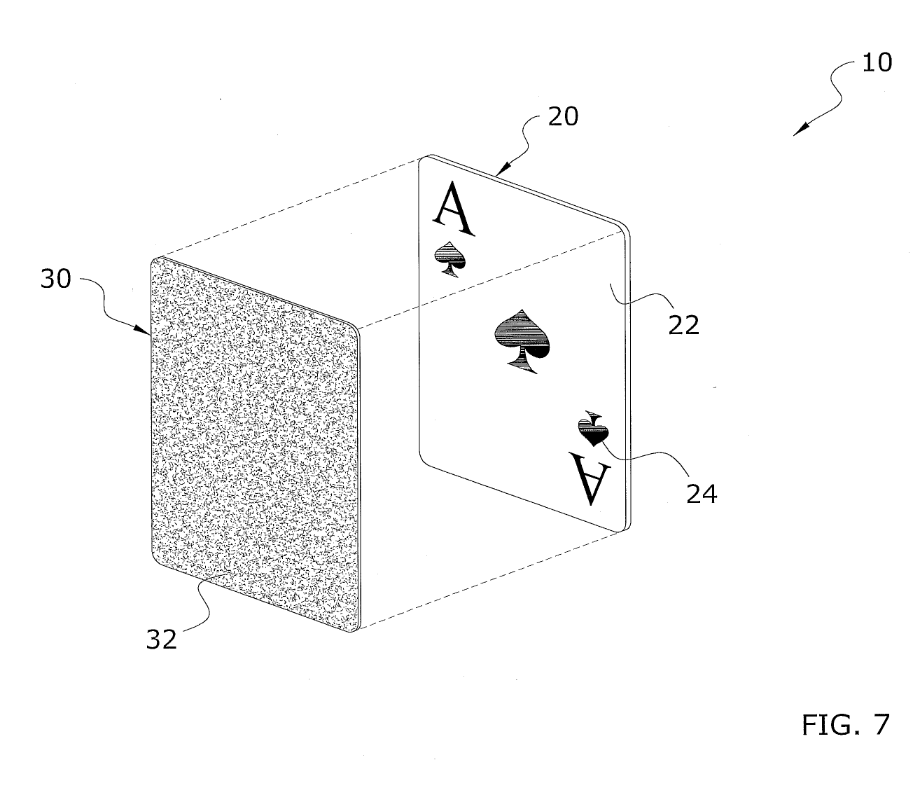

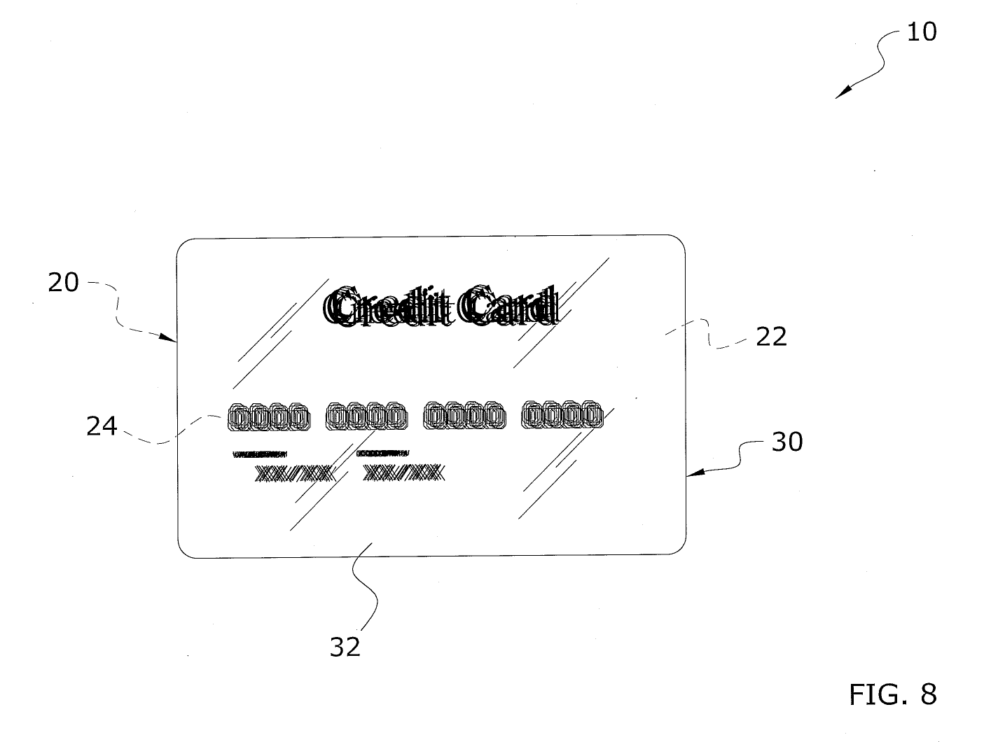

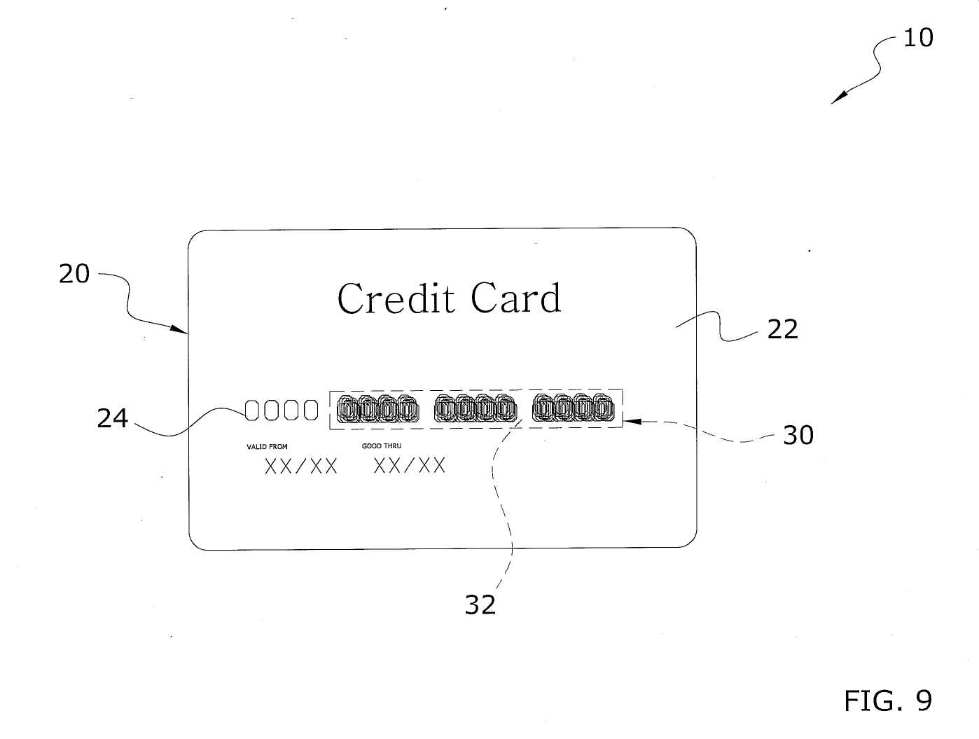

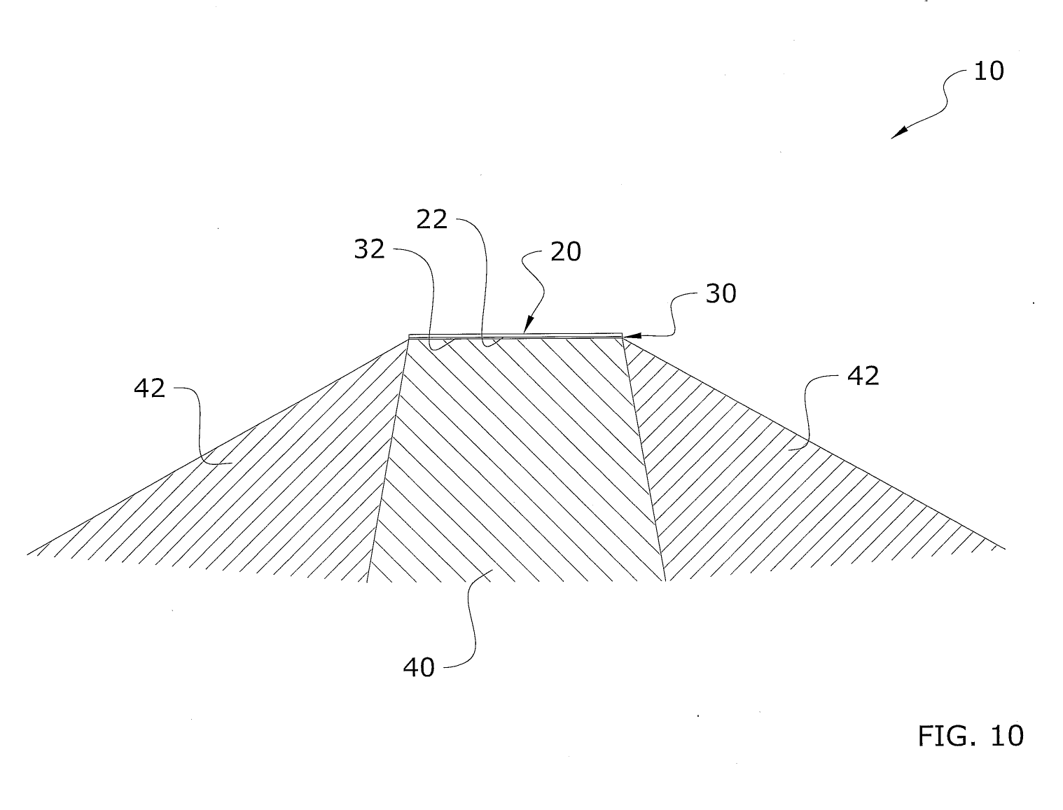

Turning now descriptively to the drawings, in which similar reference characters denote similar elements throughout the several views, FIGS. 1 through 10 illustrate a privacy cover system 10, which comprises a privacy cover 30 to attach to an information card 20 over at least a portion of information 24 upon the information card 20, wherein the privacy cover 30 aligns with the information 24 of the information card 20. The privacy cover 30 is adapted to allow viewing of the information 24 of the information card 20 through the privacy cover 30 over a first range of angles (i.e. viewing angles 40) and is adapted to prevent viewing of the information 24 of the information card 20 through the privacy cover 30 over a second range of angles (i.e. restricting angles 42) by distorting the information 24.

### B. Information Card

The information card 20 may be comprised of various types of cards 20 that a user desires to restrict view of information 24 upon the card 20 when the card 20 is at various angles. The information card 20 may be comprised of such cards 20 as transaction cards 20, such as a credit card 20 or a debit card 20, or a playing card 20, any transaction card 20, or identification cards 20, such as a driver's license, passport, an employment identification card 20, a student identification card 20 or various other types of cards 20 that include personal or confidential information 24 upon the card 20. The information card 20 may be comprised of various sizes, wherein the privacy cover 30 may adapt to the entire or partial size of the information card 20 so as to suitably cover 30 the information 24 upon the card 20.

The information card 20 includes a first face 22 generally on a front side of the information card 20. The first face 22 includes various types of information 24 to identify the user of the card 20. The information 24 may be comprised of an account number, a name, a date, a photograph or various other types of information 24. It is appreciated that the information 24 may also be positioned upon various other places of the card 20 rather than the first face 22, such as but not limited to the back side, wherein multiple privacy covers 30 may need to be used to cover 30 all of the information 24.

### C. Privacy Cover

The privacy cover 30 attaches to the first face 22 of the card 20 over the information 24 upon the first face 22 of the card 20. The privacy cover 30 is transparent and allows a user to view and read the information 24 upon the card 20 at certain viewing angles 40 and prevents a user from reading the information 24 (i.e. via causing a reflection, blurring, or distorting) upon the card 20 at certain restricting angles 42. The viewing angles 40 are generally straight on angles, wherein the line of sight of the user is perpendicular to the first face 22 of the card 20. The restricting angles 42 are generally skew angles or offset angles with respect to the line of sight of the user and the angle of the first face 22 of the card 20. Restricting the information 24 from being viewed helps to prevent the information 24 from being used by an unauthorized person, such as in theft of an account number or cheating in a playing card 20 game, such as poker.

The privacy cover 30 may cover 30 a portion of the card 20 or the whole card 20. The privacy cover 30 goes over any information 24 upon the card 20 that is desired to be restricted from view. In various embodiments, the privacy cover 30 may simply be positioned over the lower half of the first face 22, wherein all of the information 24 of the card 20 that is desired to be concealed is upon the lower half of the first face 22. It is appreciated that various other embodiments may also be utilized in positioning the privacy cover 30 upon the card 20 either on the first face 22 or a different face or side of the card 20, such as the privacy cover 30 only being positioned over the back side of the information card 20, a side of the information card 20, or the entire information card 20 (front and back). In addition, the privacy cover 30 may also be positioned over a portion of the information 24 upon the information card 20, such as a name, the account number, and/or the expiration date.

It is appreciated that when the privacy cover 30 is attached to the card 20 and the card 20 is at a viewing angle 40 the privacy cover 30 is substantially unnoticeable, wherein the privacy cover 30 is preferably clear, however it is appreciated that the privacy cover 30 may employ a slight tint. When the card 20 and privacy cover 30 are at a restricted angle, the card 20 appears blackened or substantially darkened so as not to be able to view the information 24. In alternate embodiments, the privacy cover 30 may blur the information 24 upon the information card 20, rather than darken. Various combinations of blurring, darkening, scrambling, distorting, or any type of altering to make the information 24 upon the information card 20 difficult or impossible to read, or indistinguishable at the restricting angle 42 may be employed by the privacy cover 30. It is appreciated that the information 24 upon the information card 20 may still be clear (not noticeably darkened) when at the restricting angle 42 while still being distorted, or may be darkened and not distorted, all which prevent another from viewing the information 24 upon the information card 20 at the restricting angles 42. Noticeably darkened is deemed to mean the average reader of the information card 20 would not notice that the information 24 behind the privacy cover 30 is darkened or substantially darkened, wherein the privacy cover 30 appears invisible or substantially unnoticeable especially at the viewing angles 40 and even at the restricting angles 42, wherein the information 24 is simply distorted or blurred but retains the same brightness.

The privacy cover 30 is preferably comprised of a thin and planar sheet configuration which has transparent properties and also reflective properties so that the user may view the information 24 at viewing angles 40 and prevent the information 24 from being viewed at restricted angles. The privacy cover 30 may be flexible and comprised of various materials, such as plastic. The privacy cover 30 may also be comprised of various products, such as the PRIVACY FILTER sold by 3M™. However, the PRIVACY FILTER sold by 3M™ is generally only able to restrict visibility from either the horizontal (i.e. left and right) or the vertical (i.e. up and down) direction. A product such as the UNIVERSAL PRIVACY SCREEN PRO, sold by CASE-MATE used for devices such as a BLACKBERRY™ device which provides restricted visibility in all directions (i.e. both vertically and horizontally). The CLEAR PRIVACY FILTER is made from coated acrylic panels, made by KANTEK INC. and sold by ERGO® IN DEMAND, which provides a blurred image of the information 24 viewed from a restricting angle 42, but clear when viewed from a viewing angle 40.

Other materials that may comprise the privacy cover 30 used the PRIVACY FILTER and VIKIUTI™ LIGHT CONTROL FILMS, sold by 3M™. These products use microlouver technology, which is generally only able to restrict visibility from either the horizontal (i.e. left and right) or the vertical (i.e. up and down) direction. The privacy cover 30 utilizing the above referenced or other materials may further have a glossy finish or a matte finish.

The present invention preferably utilizes materials and technology from each of the above stated products. It is appreciated that the present invention is able to restrict visibility from all directions (i.e. left, right, up, down) rather than simply from one side or the other so that persons on both the left and right sides of an individual holding an information card 20 including the privacy cover 30 will be restricted from viewing the information 24 upon the information card 20. The privacy cover 30 is further able to blur, darken, distort, or alter the information 24 upon the information card 20 in various manners to make the information 24 unreadable or indistinguishable.

The privacy cover 30 may attach to the card 20 in various manners. In one embodiment, the privacy cover 30 includes an attachment layer 35 to attach to the first face 22 or portion of the first face 22. The attachment layer 35 may be comprised of various configurations, such as but not limited to adhesive or double faced tape. In another embodiment, the privacy cover 30 is laminated upon the card 20. In another embodiment, the privacy cover 30 is integral with the information card 20. A second face 32 of the privacy cover 30 (i.e. face in which user views the information 24 through) is parallel to the first face 22 and is aligned with the information 24 upon the card 20. The privacy cover 30 may alternately statically attach to the information card 20 or use a glass tinting process to attach. It is appreciated that the privacy cover 30 may be directly attached or indirectly attached through another fastening mechanism to the information card 20. The privacy cover 30 may further be fixedly attached or removably attached to the information card 20.

It is also appreciated that the cover 30 may include differing strengths for different types of cards 20. For example, in a first strength if a credit card 20 is to be utilized a high strength privacy cover 30 may be desired in that the range of viewing angles 40 lessens and the range of restricting angles 42 widens to block views from a larger amount of angles. In another example, in a second strength if a playing card 20 is utilized a lower strength privacy cover 30 may be desired to increase the range of the viewing angles 40 so that when the playing cards 20 are laid down on the table at the end of the hand, all players may adequately view the information 24 upon the cards 20.

The privacy cover 30 further does not prevent the information card 20 from not being accepted by transaction machines, such as credit card 20 machines at retail stores, ATM machines, or other types of transaction machines. The privacy cover 30 does not interfere with the functionality of the information card 20 in any way relating to a transaction machine. The privacy cover 30 further does not interfere or disturb any necessary graphics upon the information card 20 that are needed or desired.

### D. Operation of Preferred Embodiment

In use, the privacy cover 30 is positioned over the information 24 of the first face 22 of the information card 20. The privacy cover 30 is then secured to the card 20 via the attachment layer 35, ensuring that the second face 32 of the privacy cover 30 aligns with the information 24 upon the information card 20 that is to be restricted at certain angles. When utilizing the card 20, the information 24 may be viewed through the privacy cover 30 when the card 20 is at a viewing angle 40 and the information 24 is prevented from being viewed when the card 20 is at a restricted angle via the information 24 being blurred, darkened, or various combinations thereof.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An information card concealing system, comprising:
a privacy cover to attach to an information card over at least a portion of information upon said information card, wherein said privacy cover aligns with said information of said information card;
wherein said privacy cover is adapted to allow viewing of said information of said information card through said privacy cover over a range of viewing angles;
wherein said privacy cover is adapted to prevent viewing of said information of said information card through said privacy cover over a range of restricting angles by distorting said information.

2. The information card concealing system of claim 1, wherein said information is not darkened via said privacy cover over said range of viewing angles.

3. The information card concealing system of claim 1, wherein said information is not darkened via said privacy cover over said range of restricting angles.

4. The information card concealing system of claim 1, wherein said information is darkened via said privacy cover over said range of restricting angles.

5. The information card concealing system of claim 1, wherein said privacy cover is attached over an entire front face of said information card.

6. The information card concealing system of claim 1, wherein said range of restricting angles include horizontal angles with respect to said information card.

7. The information card concealing system of claim 1, wherein said range of restricting angles include vertical angles with respect to said information card.

8. The information card concealing system of claim 1, wherein said privacy cover is comprised of a plurality of strengths to increase or decrease said range of viewing angles and said range of restricting angles.

9. The information card concealing system of claim 1, wherein said information card is comprised of a transaction card.

10. The information card concealing system of claim 1, wherein said information card is comprised of an identification card.

11. The information card concealing system of claim 1, wherein said information card is comprised of a playing card.

12. The information card concealing system of claim 1, wherein said range of viewing angles are perpendicular with said privacy cover.

13. The information card concealing system of claim 1, wherein said range of restricting angles are skew with said privacy cover.

14. The information card concealing system of claim 1, wherein said privacy cover is comprised of a flexible configuration.

15. The information card concealing system of claim 1, wherein said privacy cover includes an attachment layer.

16. The information card concealing system of claim 9, wherein said attachment layer is comprised of an adhesive layer.

17. The information card concealing system of claim 1, wherein said privacy cover is attached in a laminate manner to said information card.

18. The information card concealing system of claim 1, wherein said privacy cover is integral with said information card.

19. An information card concealing system, comprising:
a privacy cover to attach to an information card over at least a portion of information upon said information card, wherein said privacy cover aligns with said information of said information card;
wherein said privacy cover is adapted to allow viewing of said information of said information card through said privacy cover over a range of viewing angles;
wherein said information is not noticeably darkened via said privacy cover over said range of viewing angles;
wherein said privacy cover is adapted to prevent viewing of said information of said information card through said privacy cover over a range of restricting angles by distorting said information;
wherein said information is not noticeably darkened via said privacy cover over said range of restricting angles.

20. An information card concealing system, comprising:
a privacy cover to attach to an information card over at least a portion of information upon said information card, wherein said privacy cover aligns with said information of said information card;
wherein said privacy cover is comprised of a flexible configuration;
wherein said privacy cover is adapted to allow viewing of said information of said information card through said privacy cover over a range of viewing angles;
wherein said range of viewing angles are substantially perpendicular with said privacy cover;
wherein said privacy cover is adapted to prevent viewing of said information of said information card through said privacy cover over a range of restricting angles by distorting said information;
wherein said range of restricting angles include horizontal angles with respect to said information card;
wherein said range of restricting angles include vertical angles with respect to said information card;
wherein said range of restricting angles are skew with said privacy cover;
wherein said privacy cover is comprised of a plurality of strengths to increase or decrease said range of viewing angles and said range of restricting angles.
